(19) United States
(12) Patent Application Publication
(10) Pub. No.: US 2022/0137718 A1
(43) Pub. Date: May 5, 2022

(54) TOUCH TYPE KEYBOARD USING TEMPORAL EVATUATION OF TIMESTAMPS TO MODIFY KEY FUNCTIONS

(71) Applicant: Synerdyne Corporation, Santa Monica, CA (US)

(72) Inventors: Mark S. Knighton, Santa Monica, CA (US); Peter J. DeLaurentis, Burlingame, CA (US); Mydul R. Islam, Van Nuys, CA (US)

(73) Assignee: Synerdyne Corporation, Santa Monica, CA (US)

(21) Appl. No.: 16/750,544

(22) Filed: Jan. 23, 2020

Related U.S. Application Data
(63) Continuation of application No. 14/737,450, filed on Jun. 11, 2015, now abandoned.
Application No. 14/737,450 is a continuation-in-part of application No. 13/778,016, filed on Feb. 26, 2013, now Pat. No. 9,235,270.

(51) Int. Cl. G06F 3/02; G06F 3/023; G06F 1/16; H01H 13/84

(52) U.S. Cl. CPC G06F 3/0219; G06F 3/0234; G06F 1/1664; G06F 3/0216; H01H 2217/034; H01H 13/84; H01H 2217/012; H01H 2217/036; H01H 2217/004; G06F 3/0235

(57) ABSTRACT

A keyboard using temporal evaluation of timestamps. The keyboard changes the functions of keys based the temporal relation of key events on home row. Other embodiments are also described and claimed.

### RELATED MATTERS

This application is a continuation of U.S. application Ser. No. 14/737,450 entitled “TOUCH TYPE KEYBOARD WITH EMBEDDED MODIFIER KEYS” filed Jun. 11, 2015 which is a continuation-in-part of U.S. application Ser. No. 13/778,016 entitled “TOUCH TYPE KEYBOARD WITH HOME ROW EMBEDDED CURSOR CONTROL,” filed Feb. 26, 2013.

### FIELD OF THE INVENTION

Embodiments of the invention relate to a keyboard. More specifically, embodiments of the invention relate to a touch type keyboard having a reduced key set providing access to functions of a full keyboard.

### BACKGROUND

With the increasing ubiquity of mobile products, reduced sized keyboards are increasingly important. Various manufacturers have provided different types of keyboards, many of which are actually larger than the devices with which they communicate. Many keyboards provide a single layer of functions associated with particular location on the keyboard. As used herein, a “layer” refers to a character and the shift of the character. Thus, capital J and lowercase j are regarded as falling within a single layer as is commonly the case on standard touch-type keyboards. To make keyboards smaller, it can be desirable to overlap functions under the same location on the keyboard. Taken to its extreme, a typical phone keypad allows cycling through letters and symbols using multiple touches to cause the cycling. This however, does not permit efficient entry and does not constitute what is commonly regarded as a touch-typing keyboard. Generally, touch-typing keyboards are constrained by spacing between keys and single touch access to alphabetic characters. Common touch type patterns include QWERTY and AZERTY keyboards. But merely having e.g. a QWERTY pattern does not make a keyboard a touch-type keyboard. International touch typing standard requires spacing between keys to be 19 mm±1 mm. Smaller devices such as netbooks have compressed this limit, but the practical limitation for touch-typing appears to be a key spacing of greater than 14 mm. Most typists would need at least 17 mm spacing to touch type effectively.

In addition to alphanumeric keys, many existing keyboards provide additional keys for popular commonly used functions. Such functions include the cursor keys, that is the up, down, and right and left arrow keys commonly provided as dedicated keys, usually on the right side of the keyboard. Unfortunately, these cursor keys, while popular, occupy valuable real estate where form factor of the keyboard is constrained and increased cost to manufacture these additional structures must be provided. More importantly, these side-located cursor keys cause the user to leave home row frequently, which slows typing.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of a compact keyboard of one embodiment of the invention.

FIG. 2A depicts the keyboard of FIG. 1 showing only the functions accessible at a first layer in one embodiment of the invention.

FIG. 2B depicts the keyboard of FIG. 1 showing only the functions accessible at a second layer in one embodiment of the invention.

FIG. 2C depicts the keyboard of FIG. 1 showing only the functions accessible at a third layer in one embodiment of the invention.

FIG. 3 depicts a user activating the third layer functions.

FIG. 4 depicts actuation of the selection cursor functions according to one embodiment of the invention.

FIG. 5 is a diagram of one embodiment of the invention incorporated into a laptop computer.

FIG. 6 is a comparative view of a layout of an existing keyboard with one embodiment of Applicants' invention.

FIG. 7A and FIG. 7B show the manner in which the command function can be activated with either the right hand or the left hand.

FIG. 8 shows the finger chording for command+alt+L.

FIGS. 9A-9C show the mappings of the left hand sequence for the ctrl, alt and command functions.

### DETAILED DESCRIPTION

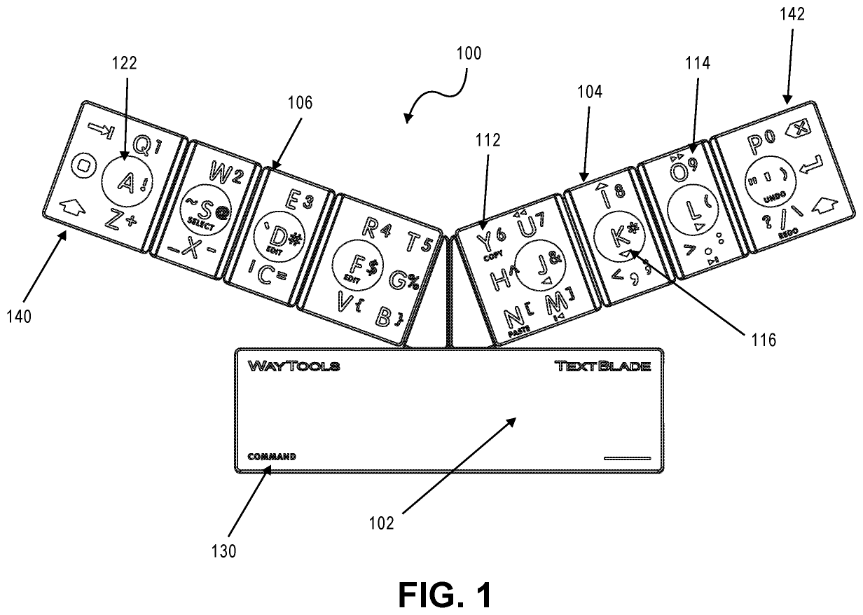

FIG. 1 is a diagram of a compact keyboard of one embodiment of the invention. Keyboard 100 may communicate wirelessly with a host device (not shown). In one embodiment, a Bluetooth module within keyboard 100 allows it to communicate with any Bluetooth-enabled device. Thus, embodiments of keyboard 100 may communicate with smartphones, tablets, laptops, desktop computers, etc. A processor within the keyboard interprets key events and transmits them to the host. Other embodiments may be wired to or otherwise physically connected to a host.

Keyboard 100 provides three layers of functions in at least some locations on the keyboard. As used herein “location” refers to both an entire key where the key is mapped to a single character, and a region of a key where a key is mapped to multiple characters, but the region is uniquely mapped to a character. “Uniquely mapped” means that, based on the existing state of the keyboard, actuation of the location unambiguously results in a single character or function. Thus, for example each alpha character on keyboard 100 is uniquely mapped to a location within the first layer 112. Within this patent application, “layer one” is used interchangeably with “first layer,” “layer two” with “second layer,” and “layer three” with “third layer.” In a default state the first layer is active. Explicit details of each layer and the changing of the mode to access the different layers is discussed below.

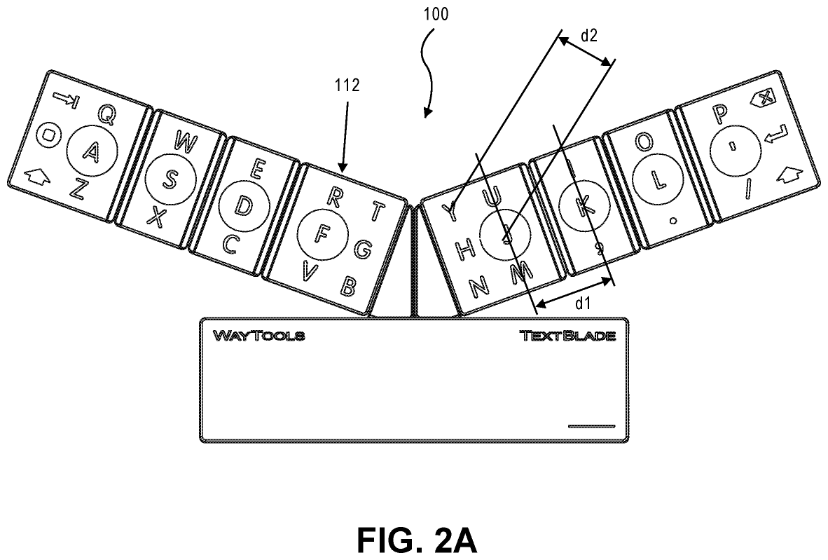

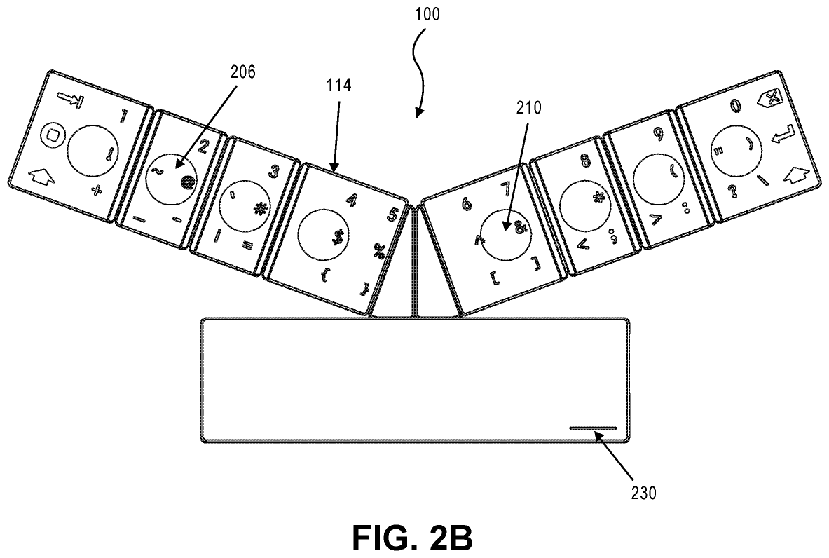

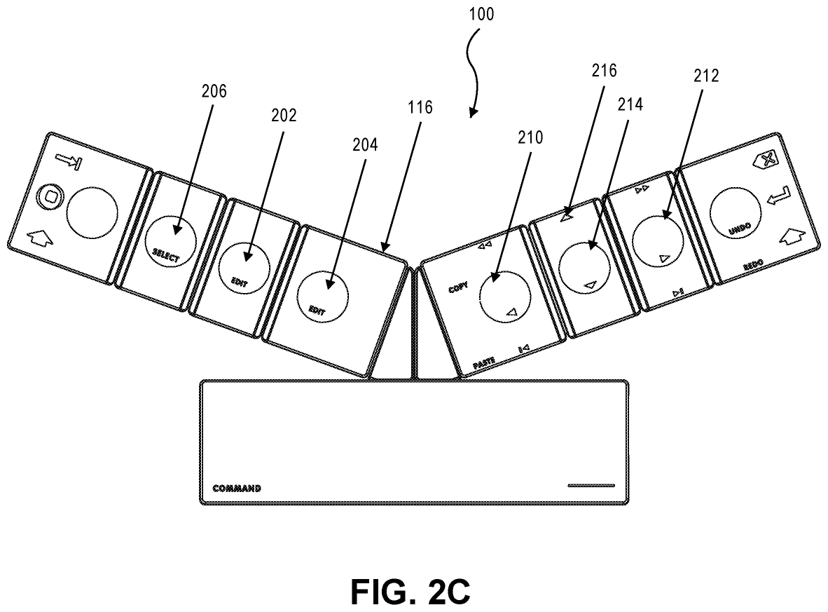

Keyboard 100 includes a spacebar module 102, a right hand key array 104 and a left hand key array 106. Spacebar module 102 provides space bar functions to the keyboard. The spacebar module 102 also provides the “command” function that is commonly available on existing keyboards. In one embodiment, the command function is selected by actuating a region on the Spacebar module 102 located near the “Command” legend 130. For example, concurrently pressing command and P is a print command for Apple® computers. Other special keys from PC keyboards, such as control, alt, option, Fn, and the “Windows Command” key, may also be supported. This can be provided through a combination of regions mapped to these functions, and/or sequential, temporal or location-based gestures. For example, double-tapping the command legend can be interpreted as the control key. In one embodiment, a controller within the keyboard 100 can detect the type of host system, such as an Apple iPhone, or a Windows PC, and automatically map the required functions to support that specific host. Right hand key array 104 includes four distinct mechanical keys that are collectively mapped to all the alphanumeric functions typically accessed by the right hand of the user on a touch-type keyboard, in this example a QWERTY layout keyboard. A left hand key array 106 similarly maps to all of the alphanumeric functions typically accessed by the left hand of a user. The letters (alpha characters) form the majority of the first layer (details of the first layer are depicted in FIG. 2A). Less commonly used characters are efficiently distributed as shown. In one embodiment, most of these functions are distributed to be accessed by a same finger as would be the case on a conventional keyboard. The numbers and these less commonly used characters form the second layer of functions associate with location on the keyboard (details of the second layer are depicted in FIG. 2B).

Additionally, cursor control and special functions are provided by the keyboard 100 at a third layer (details of the third layer are depicted in FIG. 2C). To permit a user to visually identify the functions on the keyboard both in the context of hunt-and-peck typing, and the context of lesser-used functions where even touch typists require visual confirmation, all three layers of functions should be represented at their locations on the keyboard 100. It is desirable for each layer to be represented differently to distinguish between layers. Additionally, it has been found that many different colors on a single key become “busy” and actually make finding the functions more difficult. To facilitate identification at different layers, layer one functions 112 are represented in a first color. For example layer one functions 112 may be represented in white or silver ink on a black or grey plastic key. The second layer functions 114 are represented in a second color. For example, layer two functions may be represented in metallic green or metallic blue ink on the grey or black key surface. In some embodiments, the second layer functions 114 may be represented in a smaller font than the first layer functions 112. Finally, the layer three functions 116 may be represented in the same color as the underlying key by blind-embossing (i.e. engraved) or molding the keys so these functions 116 are represented as raised indicia on the key. By having only two distinct colors of ink, finding the three layers of functions is easier for most users than a tricolor, busier indicia schema.

Keyboard 100 defines a set of home row locations, one for each finger. As used herein “finger” is any of the four digits of each hand excluding the thumb, “thumb” refers to the thumb of either hand and “digits” refers to any of the fingers or thumbs. Thus, in a QWERTY style keyboard, key array 106 has the home row location defined at the “A” location, the “S” location, the “D” location and the “F” location. The right hand key array 104 has home row locations defined at the “J”, “K”, “L”, and the apostrophe locations. This represents a repositioning of the apostrophe location to the home row instead of the “;”. But in usage today the apostrophe has higher usage than semi colon and colon and is therefore more desirable to be placed on the home row in the first layer 112. In one embodiment, a rounded well 122 defines each home row location. The rounded concave well 122 provides easy tactile identification of the home row location on the key surface for a user. Other embodiments of the invention may use some other tactile indication such as a roughened area, a raised area, or other tactilely-discernible feature that permits a user to locate the home row without looking. It is believed that some tactile indication of location is highly desirable for touch-typing.

As noted above, to compactly provide all of the functions of a standard keyboard as well as some other desirable functionality, keyboard 100 provides at least three distinct layers of functions at some locations on the keyboard. The alphabetic characters 112 exist at one layer, numbers 114 as well as special characters exist at a second layer 114, while cursor control functions and some other special functions exist at third layer 116. For example, the “K” location provides capital K and lowercase k in layer 112, an “*” in layer 114, and a down arrow function in third layer 116. The functions on the left edge 140 (tab, caps lock, and shift) and the right edge 142 (back space/delete, return, and shift) are available at all layers in one embodiment. In one embodiment the keyboard permits concurrent actuation of a letter location, and a second location, e.g. the shift location, on the same physical key. The layers are explained in greater detail with reference to FIGS. 2A-C below.

FIGS. 2A-C depict the keyboard of FIG. 1 with only a first, second and third layers of functions respectively visible. FIG. 2A shows the functions accessible at a first layer 112. This includes all of the alphabetic characters, the shift function, the caps lock function, the tab function, the delete function, the return function, the apostrophe, the backslash, period and comma. In one embodiment, the double quote grammatical symbol, the “?”, “<” and “>” are also first layer 112 functions accessible as a shift of the apostrophe, “/” “,” and “.” locations respectively. The shift may be the “up-shift” arrow depicted in the outer lower corners of the keyboard, or other function key shifts that may be provided as desired, such as the command key or related keys described above. In such embodiments these symbols are represented on the key surface in the layer one 112 color e.g. silver. Such an embodiment may be used to increase consistency with existing standard keyboards. In other embodiments these symbols form part of layer two 114 as shown in FIG. 2B. Where the symbol is not accessible in the first layer 112 it would be shown on the surface of the key in the layer two 114 color e.g. green. In normal operation, when in the layer two 114 state, all of these characters are accessible uniquely with a single key press by a finger at the location of the corresponding indicia on the key surface. Capacitive sensors within the keyboard detect the location of the user's finger on the key surface so that the key press is uniquely identified as corresponding to the desired function.

Among the problems that arise with many compact keyboards is the individual keys become too small for effective touch-typing. This is especially true for compact mobile keyboards. By aggregating multiple letters onto keys that are actually larger than standard keys, the spacing between fingers in the home row position can be maintained in a desirable range for touch-typing. For example, the spacing d₁ between adjacent home row positions for one hand is greater than 14 mm and preferably in the range of 17 mm to 22 mm. When discussing “distances” herein, the distance between two locations is defined as the center-to-center distance. That is the distance from the center of one location to the center of the other location.

Notably, in the arrangement of keyboard 100, all alphanumeric characters to be accessed by a particular finger during touch typing (1) reside on the same key and (2) occupy a location immediately adjacent to the home row location. As used here in “immediately adjacent” when modifying location means there is no location (for another character) between a location and its immediately adjacent neighbor location. All immediately adjacent locations on a key are closer to the corresponding home row location than that home row location is to any other home row location. The distance d₂, that is the distance between a home row location and an adjacent location, will be in the range of 7 mm to 18 mm, but d₂ is always less than d₁, where d₂ is defined as the distance between a home row location and any of its immediately adjacent locations on the same key, and d₁ is defined as the distance between any two immediately adjacent home row locations to be operated by a single hand during touch-typing. It is desirable that d₁ always be at least 10% greater than d₂ for every d₁ and dz. As a general matter, the distance d₂ between J and Y, or J and N, or F and T, and F and B will be the greatest throw (distance between immediately adjacent locations on any key) required to access any function. Testing has shown that the reduced throw coupled with the desirable finger spacing between adjacent finger locations on the home row increases the speed of touch-typing.

FIG. 2B depicts the keyboard of FIG. 1 showing only the functions accessible at a second layer in one embodiment of the invention. In one embodiment, layer two 114 functions are accessed via a selection function 230 on the spacebar module. The line in location 230 on the spacebar module 102 is, in one embodiment, instantiated in the same color (e.g. green) as the layer two functions on the other key arrays 104, 106. In one embodiment, actuation of location 230 on the space bar module 102 with a single tap transitions to layer two 114 for the immediately succeeding key event. Tapping location 230 twice in rapid succession latches the keyboard into layer two 114 until the latch is released by, for example, a further actuation of location 230, or a time-out. Alternatively, layer two 114 can be maintained by continuous actuation of location 230. In some embodiments, when the keyboard 100 detects that the user has lifted his fingers off the home row, it may be configured to automatically shift to another layer. For example, if the user moves his hand away to scan the green legends, the keyboard may automatically enter the layer two 114 state for a period of time to allow the user to select a green legend function without pressing a green shift key. If the keyboard detects the return of fingers to home row, the keyboard can be set to automatically return to layer one 112 functionality. Such automatic detection and shifts may also be accomplished by other means such as monitoring keyboard entry data. Modes may be maintained for an unlimited period of time for example, until a certain key input is received.

This layer 114 includes the numbers 0-9, each located to be associated with the same finger that would be used for that number on a standard keyboard. Additionally, the symbols that are the shifts of the numbers are directly accessible in this layer without a shift, and immediately adjacent so as to associate with the same finger as on a standard keyboard. Finally, the lesser-used symbols such as brackets and less common punctuation are distributed in this layer. On the small keys, that is, those keys used by the middle and ring fingers, two symbols may be accessed at one location. This is performed using the normal “up-shift” function, as with shifting between upper and lower case in the alpha layer 112. In the nomenclature of this embodiment, the symbol on the left of the key is the shifted variant, and the symbol on the right is directly accessible without a shift. For example, in this layer 114 the “@” is directly accessible by the ring finger at the home row location 206 without a shift. The “˜” is accessible as a shift of that same home row location 206. In one embodiment all of the large keys, i.e. those keys accessed by the index and pinky fingers, have a single layer two 114 function per location, and hence can be accessed without a shift. For example, at layer 114 the “]” can be accessed without a shift by actuating the “M” location, and the “[” can be accessed without a shift by actuating the “N” location, which is below and to the left of the “J” home row location 210. Access to symbols that are commonly used together, such as the brackets, has been found to enhance usability when those symbols can be accessed by the same finger.

The functions of this layer are depicted in a second color different from the characters in the first layer. It is desirable that the second color be less obtrusive than the first color. In one embodiment, the functions of this layer are depicted in metallic green ink. Testing has shown that metallic green ink (such as Pantone 10316C) performed best in bright and dim ambient light conditions to provide both good visibility in low light as well as sufficient subtlety relative to the alphabet color when viewed in bright light. Other embodiments may use other inks, such as Pantones 10317C or 10318C which have also be found to have desirable characteristics.

FIG. 2C shows only the third layer. In one embodiment, the indicia for this layer are blind-embossed on the keys. As such, indicia are molded recesses that have the same color as the underlying plastic of the key. Alternatively, they can be indicia that are raised relative to the surface of the key, and also molded in the same plastic and color. This layer provides special functions such as cursor control functions. Left arrow 210 occupies the home row J location, right arrow 212 occupies the L home row location, down arrow 214 occupies the home row K location and up arrow 216 occupies the I location. Cursor control locations 210-216 form a typical inverted-T cursor control pattern familiar to users. Significantly, however, because the cursor control is embedded in the home row, it is faster and more convenient to access. As is described below, the “edit” locations 202 and 204 occupy the D and F home row locations, and permit access to this layer 116 and in particular to the embedded home row cursor control functions 210-216. Similarly, the select function at the S home row location 206 converts the cursor control functions into selection functions. Other useful functions such as copy, paste, undo, redo, go to beginning of line, go to end of line, go to next word, select next word, go to previous word, select previous word, go to next sentence, go to previous sentence, select next sentence, select previous sentence, go to next paragraph, select next paragraph, go to previous paragraph, select previous paragraph, page up, page down, go to start of page, go to end of page, go to start of document, go to end of document, an edit control, a cursor selection control for a zone of text, play, pause, fast forward, rewind, skip forward, skip backward, volume up, volume down, mute, and a media control may be provided at layer three 116.

Table 1 shows one possible mapping of layer three 116 functions with the activating key combinations:

TABLE 1

| | | SELECTION | |
|---|---|---|---|
| | EDIT | (Move cursor and | AUDIO |
| | (Move position | grow/shrink | (Adjust audio/ |
| | of edit cursor) | selection zone . . . ) | video playback.) |
| Locations | D, F | S, F, D | A, S, F, D |
| to actuate | | | |
| concurrently | | | |
| to enter | | | |
| this state | | | |
| Location | | | |
| J [symbol] | Move cursor left | . . . by one character | Pause. |
| | one character | to the left. | |
| L [symbol] | Move cursor | . . . by one character | Play/Pause |
| | right one | to the right, | toggle. |
| | character | | |
| I ▴ | Move cursor up | . . . by the line | Volume up |
| | one line | above. | |
| K ▾ | Move cursor | . . . by the line | Volume down |
| | down one line | below. | |
| U [symbol] | Jump cursor one | . . . by one word to | Rewind |
| | word to the left | the left (or by one | |
| | (or by one | sentence in some | |
| | sentence in some | apps) | |
| | apps) | | |
| O [symbol] | Jump cursor one | . . . by one word to | Fast forward |
| | word to the right | the right (or by one | |
| | (or by one | sentence in some | |
| | sentence in some | apps) | |
| | apps) | | |
| M [symbol] | Jump to the | . . . to include the | Previous Track |
| | beginning of line | beginning of the | |
| | (or paragraph in | line (or paragraph | |
| | some apps) | in some apps) | |
| [symbol] | Jump to end of | . . . to include the | Next Track |
| | line (or | end of the line (or | |
| | paragraph in | paragraph in some | |
| | some apps) | apps) | |

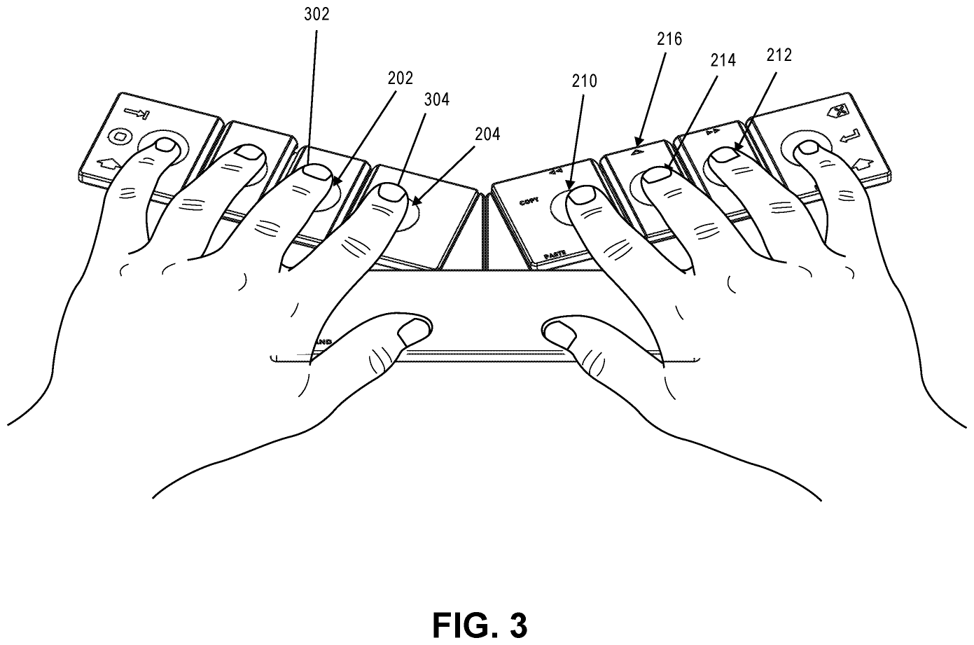

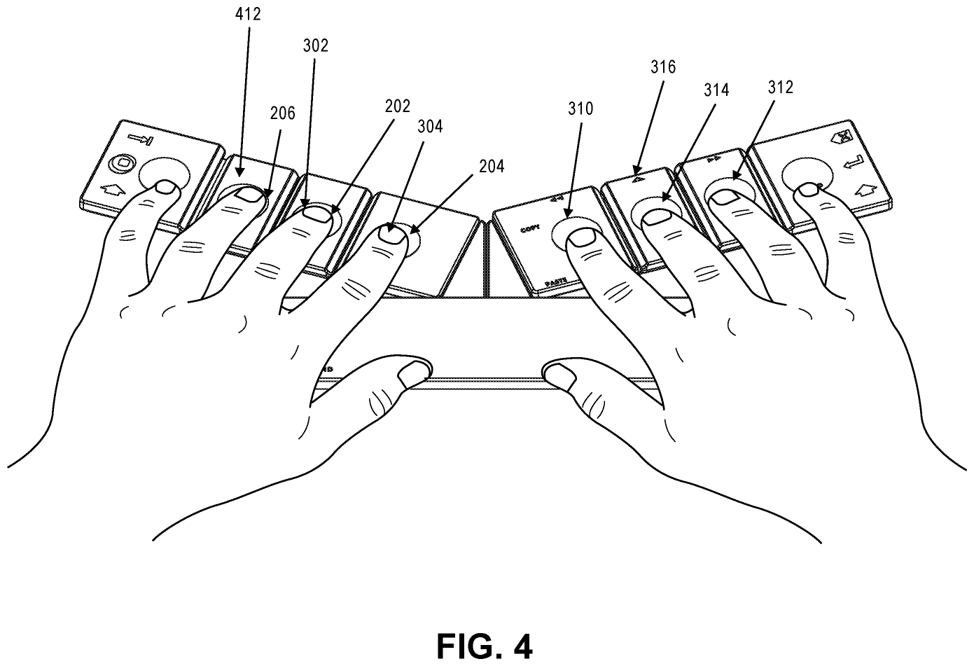

The first row of Table 1 shows the location combination that allows the user to access that functionality. The first column shows the layer one locations in correspondence with the layer three functions symbol. The remainder of the table sets forth the function associated with the particular symbol in different states of layer three 116 operation. Accessing the layer three 116 functions is discussed in more detail with reference to FIGS. 3 and 4 below.

FIG. 3 depicts a user activating the third layer functions. When the home row “edit” locations 202 and 204 are concurrently actuated, a processor within the keyboard identifies this as a signal to switch to the third layer functions. Thus, by concurrently actuating two home row locations, three other home row locations and the “I” location are converted to cursor control functions. Because of the tactile features (wells 122) and the adjacency of other locations, this provides a fast and efficient swap between alpha characters and cursor control. Moreover, it can all be done without looking at the keyboard. It is not of course mandatory that the concurrent actuation of locations for switching modes both be on home row. However, having one location on home row provides an anchor. Thus, it is within the scope and contemplation of the invention that the switch to cursor mode could be performed by concurrently actuating e.g. location 202 and the location immediately below, above or otherwise adjacent to 204. Such would be deemed to be within the scope and contemplation of the invention.

However, it is deemed to be fundamentally different where a user must leave the home row completely to instigate the change. The risk of error and the coincident requirement of visual confirmation renders combinations of locations exclusive of home row less desirable for providing the touch-type transition without requiring visual confirmation. In this example, index finger 304 actuates location 204 and middle finger 302 actuates location 202 allowing a right hand index, middle and ring finger to access cursor control functions 210-216 directly while anchored on the home row. In one embodiment, the other functions at layer three 116 such as cut and paste are also enabled by the concurrent actuation of locations 202 and 204. It is within the scope of the invention to swap the triggering array with the cursor control array. For example one embodiment of the invention may use the J location and the K location to enter cursor control mode and use the S, D, F and E locations as the inverted T cursor control. Left-handed users may prefer this arrangement. In one embodiment a firmware toggle permits such a swap. For purposes of this invention, concurrent actuation shall mean overlapping in time. In order to determine the start and finish of a key actuation at one location relative to another, a controller within the keyboard 100 can apply a timestamp to each key event. In this way, the controller can determine which key event occurred first, and how long the gap in time was between a first and second key event constituting a concurrently overlapping pair. These timestamps may be used after the physical key event has occurred, but before reporting the resultant determination to the host. In this way, very high time and sequence precision can be achieved.

In one embodiment, the keyboard remains at the third layer only so long as both triggering locations (here 202, 204) are actuated concurrently. In an alternative embodiment, after the keys have been actuated concurrently, the mode is latched within a processor in the keyboard, and the keyboard remains at layer three 116 until triggered to leave that state. In one embodiment, the trigger to leave the mode and e.g. return to layer one 112 (the alpha characters), may be the next concurrent actuation of the triggering locations (here 202, 204). Thus, the concurrent actuation of these locations acts as a toggle between the cursor control mode and the alpha mode. Alternatively, one concurrent actuation of the trigger locations could modify only the next key struck. It is within the scope of the invention to allow for concurrent actuation of the triggering locations (here 202, 204) at the same time as the key that is modified by switching layers. Exiting layer three 116 may also be triggered after a defined time period where none of the triggering locations (here 202, 204) are pressed. Combinations of these options are also possible. For example, one embodiment may alternatively remain in layer three 116 mode while the keys are concurrently actuated, but also respond to a momentary actuation by latching the mode for a single immediately following actuation.

In some embodiments, actuation of an additional location converts the third layer keys to an audio control state. For example, in one embodiment concurrently actuating all four left hand home row locations (A, S, D, F) converts the third layer keys to audio controls. In some embodiments, “audio” may be blind-embossed in association with the “A” location. In some embodiments, audio control may be entered by concurrently actuating the “A” location with only one or two other locations on the keyboard. The Audio control state may also be latched, exited, or otherwise toggled as described above.

In an alternative embodiment, holding down a single home row location, e.g. location 202 with the left hand, causes actuations of other locations to be interpreted as actuation of a layer three 116 function. By way of example, concurrent actuation of location 202 by the left hand, and 214 by the right hand, would result in a down arrow function in this alternative embodiment, however care must be taken to avoid confusion with intentionally distinct keyboard “rollover” events.

FIG. 4 depicts actuation of the selection cursor (“select” cursor) functions according to one embodiment of the invention. To convert from standard cursor functions to “select” cursor function, in one embodiment of the invention, the ring finger 412 actuates the home row location 206 concurrently with the actuation of home row locations 202 and 204 by middle finger 302 and index finger 304. In another embodiment of the invention the location actuated to convert to select cursor function may not be on the home row. When in the select state, the cursor jumps to the next block of text (a character, word, line, paragraph etc., as the case may be), and automatically highlights the entire block of text for a desired operation. Cursor control functions 310-316, and the others shown for example in Table 1, act to select a defined text block to permit for example, copy and paste functions. Similarly, with the select function it may remain active only while all three locations 206, 202 and 204 are concurrently actuated, or it may be latched by the initial concurrent actuation of the three locations 202-206. In the latched case, concurrent reactuation of the three locations 202, 204, 206 may be used to exit the selection state. Each of the cursor and selection functions may also be assigned to other functions outside the context of text processing applications, such as navigation and selection of thumbnail images or application icons. It is within the scope of the current invention to create an application that responds to inputs from the keys on layer three 116 in the manner contemplated above. It is also within the contemplated scope of this invention that selections marked with this layer three functionality may persist on the host device or application after completing a selection, even after exiting the selection state or leaving layer three.

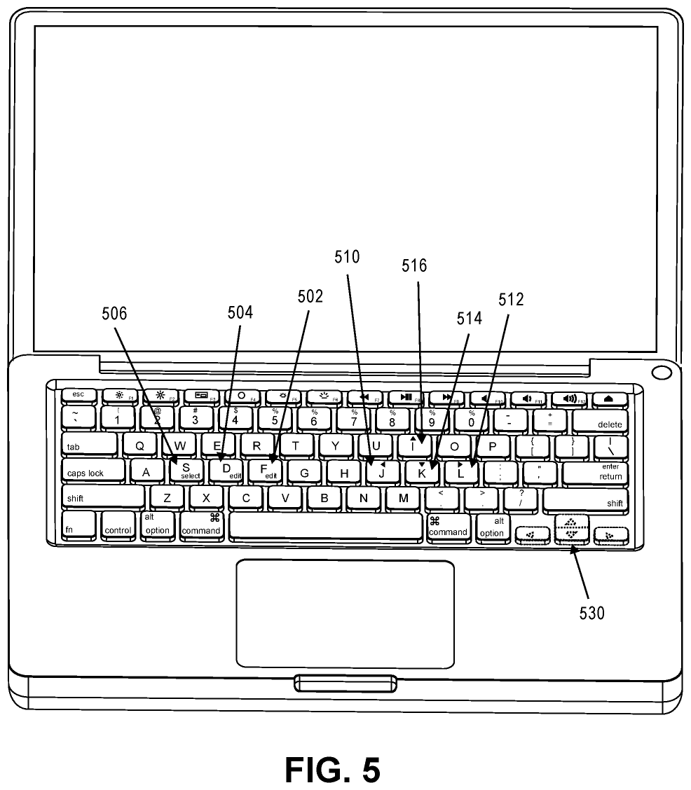

FIG. 5 is a diagram of one embodiment of the invention incorporated on a laptop computer. In one embodiment, the D key 504 and the F key 502 are mapped to the “edit” function such that the concurrent actuation of keys 502 and 504 causes the J, K, L, and I keys (510, 514, 512, 516) to be remapped to the inverted-T cursor control keys. This allows for the elimination of dedicated cursor control keys 530 typical on today's laptop computers. Additionally, it allows efficient reduced-motion access to cursor controls on other standard touch type keyboards. In one embodiment, this remapping is performed by firmware resident within the laptop. In other embodiments, the remapping is performed by one of the operating system (O/S), a keyboard device driver, or a software application installed on the O/S. While the laptop is used as an example, this functionality would be useful with standard keyboards used with desktop computers as well as any small mobile device with integrated touch type keyboards such as notebooks, netbooks, tablet case or cover keyboards, etc. In one embodiment, the keyboard 100 described with reference to FIGS. 1-4 above can be wholly integrated into a laptop etc. replacing the standard keyboard such as shown in FIG. 5.

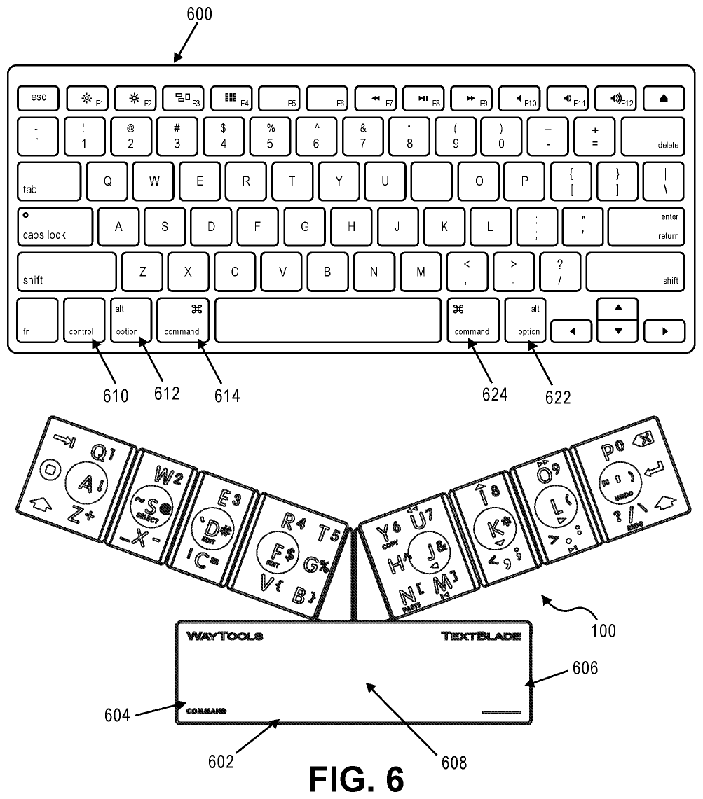

FIG. 6 is a comparative view of a layout of an existing keyboard with one embodiment of Applicants' invention. Keyboard 600 represents existing mobile keyboards that have a control key 610, alt key 612, and command key 614 in increasing proximity to the left side of a spacebar. A redundant command and alt key 624 and 622 are providing in increasing proximity from the right end of the spacebar. Mobile keyboard 100 does not have any dedicated key for command, ctrl or alt.

Mobile Keyboard 100 has two arrays of character keys and a spacebar 602. In one embodiment, the character arrays have four physical keys each. In other embodiments, the larger keys of the arrays may be “split” into two keys so that the total key count would be up to twelve (six on each array).

Spacebar 602 has three distinct regions that may be used to transition the keyboard into a other modes. The middle 608, the left corner 604 and the right corner 606 are distinctly readable zones. Actuation of the spacebar within one of these zones concurrently with locations on the right or left hand key array can result in different functions not available on any individual key. In one embodiment, the left corner 604 actuated concurrently with zones on the right or left array of keys provides access to additional symbols, foreign language accents, or emoji. In another embodiment, the middle zone 608 concurrently actuated with zones on the right or left array of keys provides access to ESC and certain cursor functions. In one embodiment, the right corner zone 606 concurrently actuated with zones on the right or left array of keys provides access to F1-F15 functions. Table 2 below shows one possible mapping, but other mappings are with in the scope and contemplation of the invention. The mapping of Table 2 does not use the left corner zone 604 but it could be mapped interchangeably with the right corner 606, or left open for future use. One advantage of the three-zone arrangement is that it is tactilely easy to tell if you are in a corner as opposed to the middle and all three zones are easily accessible with the thumbs while the fingers remain on the character arrays. In some embodiments of the invention, it is not necessary to concurrently actuate the spacebar with those other locations. Rather, actuating the right or left corner transitions into a mode where other functions are available, as shown in Table 2.

TABLE 2

| | Left Hand | Right Hand | Space Bar |
|---|---|---|---|
| Ctrl | Z X | M , | |
| Alt | X C | , . | |
| Command | C V | . / | |
| Ctrl Command | Z V | M / | |
| Ctrl Alt | Z X C | M , . | |
| Alt Command | X C V | , . / | |
| Ctrl Alt Command | Z X C V | M , . / | |
| Example: Ctrl P | Z X | P | |
| Example: Command S | S | M , | |
| Example: Ctrl Alt L | Z X C | L | |
| Example: Ctrl Cmd J | Z V | J | |
| Esc | Tab | | Middle |
| Home | D F | J | Middle |
| End | D F | L | Middle |
| Page Up | D F | I | Middle |
| Page Down | D F | K | Middle |
| F1 | Q | | Right Corner |
| F2 | W | | Right Corner |
| F3 | E | | Right Corner |
| F4 | R | | Right Corner |
| F5 | T | | Right Corner |
| F6 | | Y | Right Corner |
| F7 | | U | Right Corner |
| F8 | | I | Right Corner |
| F9 | | O | Right Corner |
| F10 | | P | Right Corner |
| F11 | A | | Right Corner |
| F12 | S | | Right Corner |
| F13 | D | | Right Corner |
| F14 | F | | Right Corner |
| F15 | G | | Right Corner |

Table 2 shows the chording mappings of locations on keyboard 100 to achieve different functions, such as ctrl, alt/option, command, combinations of those functions, and combinations of those functions with additional letters, as well as functions F1 through F15, and Esc. As used in this table “alt” and “option” are interchangeable.

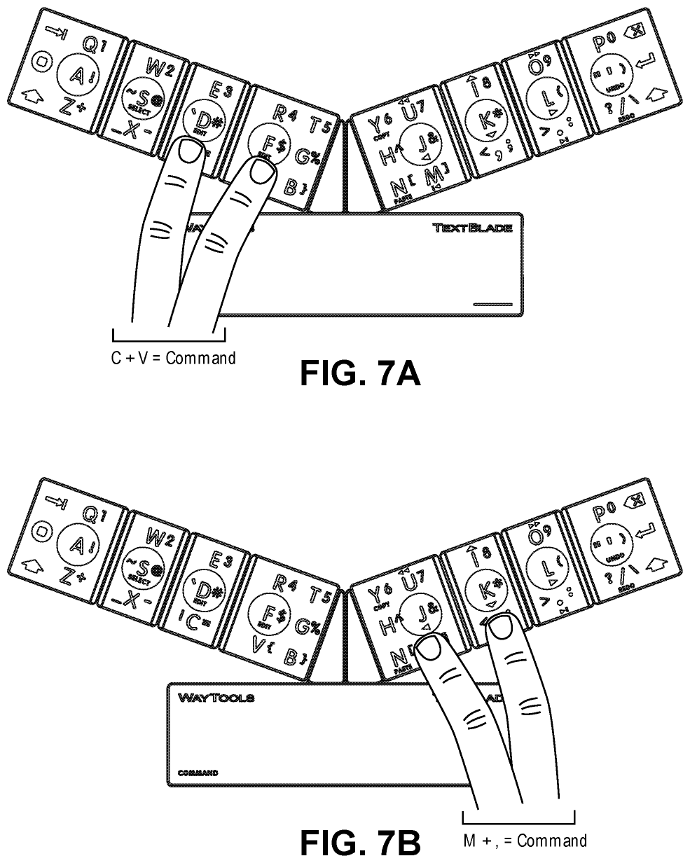

FIG. 7A and FIG. 7B show the manner in which the command function can be activated with either the right hand or the left hand. As shown in FIG. 7A, the left hand can achieve the command function by chording C and V, that is, actuating the C and V locations on the keyboard concurrently. Similarly, as shown in FIG. 7B, concurrently actuating the M location and the comma location allows activation of the command function with the right hand. By providing redundant ctrl, alt, and command, all three functions or any combination of these functions can be accessed with either hand, and they can be chorded with letters of the other hand. Additionally, each is proximate to the physical location that the physical key occupies in a conventional keyboard, facilitating learning and subsequent ease of use.

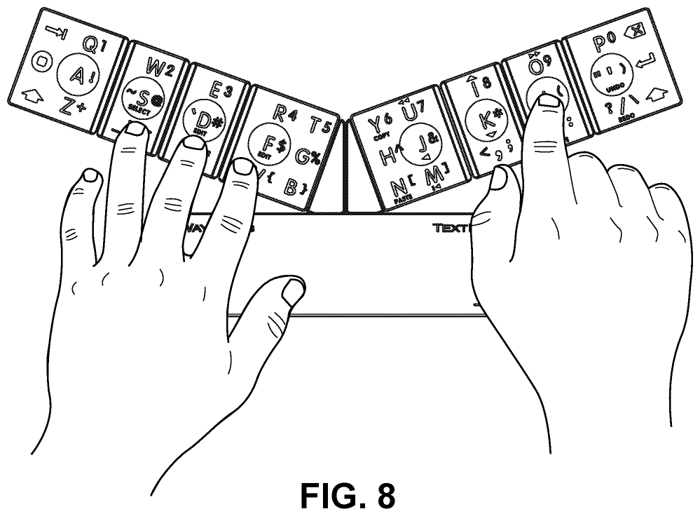

FIG. 8 shows the finger chording for command+alt+L. In this instance, the V location, the C location and X location are concurrently actuated along with the L location. As noted above, the chording locations associated with each of the functions command, alt and ctrl are located near where those locations would be found on a historical keyboard. Moreover, each of these functions can be actuated with either hand. Thus, command+alt+D uses a right hand chord for the command+alt portion, and D can be actuated with the left hand.

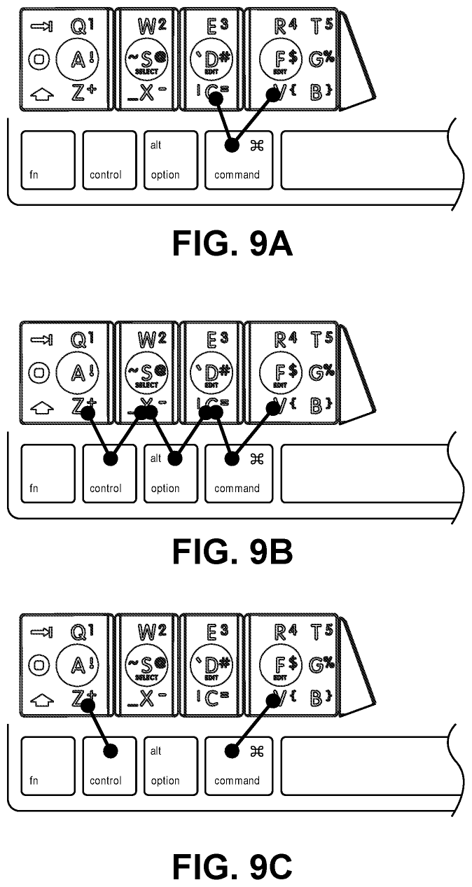

FIGS. 9A-9C show the mappings of the left hand sequence for the ctrl, alt and command functions. FIG. 9A reveals that concurrently actuating the C and V locations with the left hand results in a command function. FIG. 9B shows that concurrently actuation V, C, X and Z locations achieves the chording of control+alt+command, thus giving all three functions currently. Also revealed in FIG. 9B is that alt alone is actuated by X and C together, and ctrl alone is actuated by Z and X together. FIG. 9C shows command+ctrl is achieved by concurrently pressing V and Z. Notably this does not include the full chord for either function on its own. Rather it eliminates the alt chord that contributes to each function individually and reduces the risk of chord confusion. A mirror relation exists for these functions when actuated with the right hand.

In the foregoing specification, the embodiments of the invention have been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A touch type keyboard comprising:
an array of tactile keys defining a home row of locations that allow each of eight fingers to rest concurrently in the course of touch-typing, and providing single stroke access to every letter of a full alphabet through unique locations on the array; and
a controller configured to apply a timestamp for each of a plurality of key actuation events at the different key locations,
wherein the controller is configured to identify when at least one of the home row locations and a second home row location are actuated concurrently as a signal to switch a function of a third location in the array to a different keyboard function; and
wherein the identification is based at least in part, on a temporal relation of the timestamps; and wherein the controller is configured to evaluate the temporal relation after the events have occurred and before reporting the events to the host.

2. The keyboard of claim 1 wherein the concurrent actuation of the at least two home row locations maintains the different keyboard function of the third location only during the concurrent actuation.

3. The keyboard of claim 1 wherein the concurrent actuation of the at least two home row locations activates a latched state which maintains the different keyboard function of the third location for some period after the concurrent actuation.

4. The keyboard of claim 1 wherein the second location and the third location having the different keyboard function are at the same location.

5. The keyboard of claim 1 wherein the function at the third location is an alphabetic function and the different keyboard function is a cursor key function at the same location.

6. The keyboard of claim 5 wherein a set of cursor key functions is arranged in an inverted T pattern at the third location.

7. The keyboard of claim 6 where in the inverted T pattern overlays the cursor function up with an “I” location, down with a “K” location, right with an “L” location and left with a “J” location.

8. The keyboard of claim 5 wherein actuating an additional location on the array while operating the cursor key produces a cursor function that allows selection of a range of text.

9. The keyboard of claim 1 wherein the different keyboard function is at least one of copy, paste, undo, redo, go to beginning of line, go to end of line, go to next word, select next word go to previous word, select previous word, go to next sentence, go to previous sentence, select next sentence, select previous sentence, go to next paragraph, select next paragraph, go to previous paragraph, select previous paragraph, page up, page down, go to start of page, go to end of page, go to start of document, go to end of document, an edit control, a cursor selection control for a zone of text, play, pause, fast forward, rewind, skip forward, skip backward, volume up, volume down, mute, and a media control.

10. The keyboard of claim integrated with a computer having a display.
